(19) United States
(12) Patent Application Publication
(10) Pub. No.: US 2026/0222633 A1
(43) Pub. Date: Jul. 30, 2026

(54) System and Method for Alternate Channel Generation

(71) Applicant: Paramount Global, New York, NY (US)

(72) Inventors: Gregg William RIEDEL, New York, NY (US); Jeff HESS, New York, NY (US)

(21) Appl. No.: 19/038,409

(22) Filed: Jan. 27, 2025

(51) Int. Cl. H04N 21/234; H04N 21/262; H04N 21/61; H04N 21/81

(52) U.S. Cl. CPC H04N 21/23424; H04N 21/26258; H04N 21/6193; H04N 21/8146

(57) ABSTRACT

A system for alternate channel generation includes first and second channel playout systems and a storage. The first system reads a playlist and outputs a first channel feed according to the playlist. The first system ignores one or more special commands in the playlist. The second system reads the playlist and outputs a second channel feed according to the playlist. The second system reads the one or more special commands in the playlist. The storage is accessible by the second system and not accessible by the first system. The storage stores special content including at least one of special video content or special graphics. The second system reads the one or more special commands in the playlist causes the second system to retrieve the special content and insert the special content in the second feed. The first system does not insert the special content in the first feed.

### BACKGROUND

A satellite broadcasting system can transmit a channel from a transmission site for reception and retransmission by a satellite. The satellite includes a transponder for receiving the channel over uplink frequencies and retransmitting the channel over downlink frequencies for reception by a ground station and distribution to customers, e.g., via a local distributor. In some cases, it may be preferable to modify the content of a channel for selected viewers while concurrently providing the unmodified channel to other viewers.

### SUMMARY

The present disclosure relates to a system for alternate channel generation. The system includes a first channel playout system configured to read a playlist and output a first channel feed according to the playlist, the first channel playout system configured to ignore one or more special commands in the playlist; a second channel playout system configured to read the playlist and output a second channel feed according to the playlist, the second channel playout system configured to read the one or more special commands in the playlist; and a storage accessible by the second channel playout system and not accessible by the first channel playout system, the storage configured to store special content including at least one of special video content or special graphics. The second channel playout system is configured to read the one or more special commands in the playlist causes the second channel playout system to retrieve the special content and insert the special content in the second channel feed. The first channel playout system does not insert the special content in the first channel feed.

In an embodiment, a first special command including a special prefix, the first channel playout system reading the special prefix causing the first special command to be inert, the second channel playout system reading the special prefix causing the first special command to be actioned.

In an embodiment, the special prefix comprising an asset ID prefix comprising a reserved keyword.

In an embodiment, the playlist includes a first standard command for inserting a first standard video content and a first special command for inserting a first special video content, the first channel playout system ignoring the first special command and outputting the first standard video content, the second channel playout system reading the first special command and outputting the first special video content, wherein, when the first special video content overlaps the first standard video content, the first special video content overrides the first standard video content in the second channel feed.

In an embodiment, the first standard video content and the first special video content comprise a same duration so that the first special video content directly overlaps the first standard video content.

In an embodiment, the first standard video content comprises a first duration and the first special video content comprises a second duration. When the first duration is greater than the second duration, the second channel playout system outputs the first special video content for the second duration then outputs black for a remainder of the first duration.

In an embodiment, the first standard video content comprises a first duration and the first special video content comprises a second duration. When the second duration is greater than the first duration, the second channel playout system cuts off the first special video content and switches to a different playout source.

In an embodiment, the playlist includes a first special command for inserting a first special graphic in the second channel feed for a predetermined duration.

In an embodiment, the first special graphic comprises a crawl graphic.

In an embodiment, the system further includes a first satellite uplink transmitting the first channel feed on first uplink frequencies to a first satellite for retransmission to a first downlink station; and a second satellite uplink transmitting the second channel feed on second uplink frequencies to a second satellite for retransmission to a second downlink station.

In an embodiment, the second channel playout system receives the first channel feed from the first channel playout system and actions only the one or more special commands to overlay the first channel feed with the special content.

In an embodiment, a method for alternate channel generation includes load a playlist to a first channel playout system configured to read the playlist and output a first channel feed according to the playlist, the first channel playout system configured to ignore one or more special commands in the playlist; load the playlist to a second channel playout system configured to read the playlist and output a second channel feed according to the playlist, the second channel playout system configured to read the one or more special commands in the playlist; access a storage by the second channel playout system, the storage configured to store special content including at least one of special video content or special graphics; based on the one or more special commands, retrieve from the storage the special content; insert the special content in the second channel feed; output, by the second channel playout system, the second channel feed including the special content; and output, by the first channel playout system, the first channel feed not including the special content.

In an embodiment, the second channel playout system receives the first channel feed from the first channel playout system and actions only the one or more special commands to overlay the first channel feed with the special content.

In an embodiment, a first special command includes a special prefix, the first channel playout system reading the special prefix causing the first special command to be inert, the second channel playout system reading the special prefix causing the first special command to be actioned, the special prefix comprising an asset ID prefix comprising a reserved keyword.

In an embodiment, the playlist includes a first standard command for inserting a first standard video content and a first special command for inserting a first special video content, the first channel playout system ignoring the first special command and outputting the first standard video content, the second channel playout system reading the first special command and outputting the first special video content, wherein, when the first special video content overlaps the first standard video content, the first special video content overrides the first standard video content in the second channel feed.

In an embodiment, the first standard video content comprises a first duration and the first special video content comprises a second duration. When the first duration is greater than the second duration, the second channel playout system outputs the first special video content for the second duration then outputs black for a remainder of the first duration. When the second duration is greater than the first duration, the second channel playout system cuts off the first special video content and switches to the first channel feed.

In an embodiment, the playlist includes a first special command for inserting a first special graphic in the second channel feed for a predetermined duration, wherein the first special graphic changes location over time on the second channel feed.

In an embodiment, the method further includes transmitting the first channel feed by a first satellite uplink on first uplink frequencies to a first satellite for retransmission to a first downlink station; and transmitting the second channel feed by a second satellite uplink feed on second uplink frequencies to a second satellite for retransmission to a second downlink station.

In an embodiment, the method further includes transmitting a command to the second downlink station causing the second downlink station to tune to downlink frequencies transmitted by the second satellite.

### BRIEF DESCRIPTION OF THE DRAWINGS

FIG. 1 shows a broadcast system according to one example.

FIG. 2 shows a diagram for channel playout according to one example.

FIG. 3 shows an exemplary diagram for transmitting an uplink signal by a satellite uplink according to one example.

FIG. 4 shows a diagram for receiving a downlink signal by a satellite downlink according to one example.

FIG. 5 shows a diagram for alternate channel playout according to various exemplary embodiments.

FIG. 6 shows an exemplary diagram for transmitting a first uplink signal carrying a primary channel and a second uplink signal carrying an alternate channel according to various exemplary embodiments.

### DETAILED DESCRIPTION

The exemplary embodiments may be further understood with reference to the following description and the related appended drawings, wherein like elements are provided with the same reference numerals. The exemplary embodiments relate to systems and methods for a broadcaster to provide alternate channels including special content to a selected one or more receiving entities (e.g., distributors and/or customers downstream in the broadcast chain) while concurrently providing unmodified channels (e.g., excluding the special content) to different receiving entities.

In any multichannel broadcasting or streaming environment, there exists a plurality of channels, e.g., video/audio presentations with attendant metadata. The channels may be delivered via satellite or terrestrially over computer networks, e.g., using a streaming service through, for example, a web site, a mobile video provider, etc.

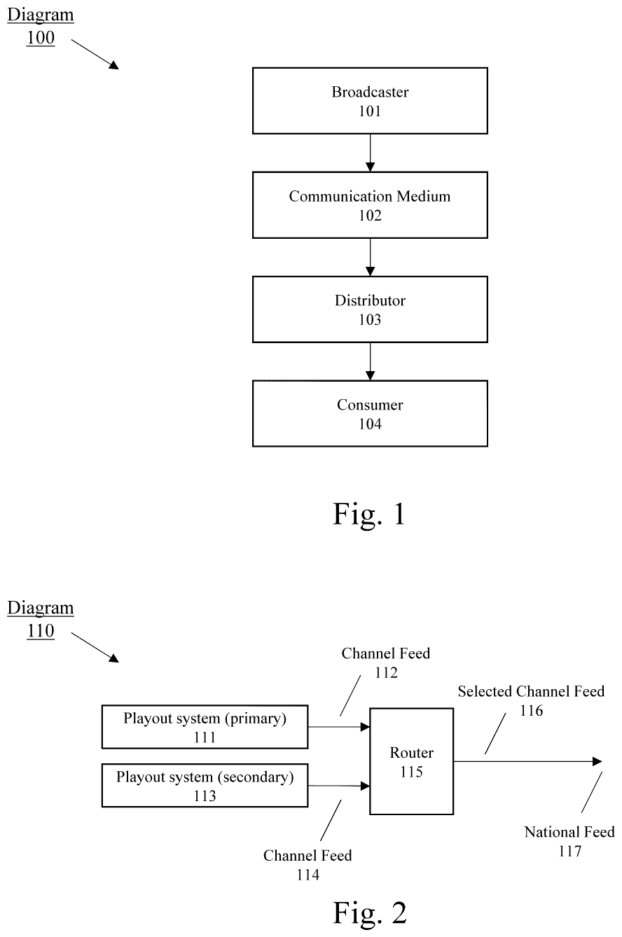

FIG. 1 shows a broadcast system 100 according to one example. The broadcast system 100 relates to a channel transmission procedure, e.g., to be used for a television broadcast or a streaming media service. The broadcast system 100 may include a broadcaster 101, a communication medium 102, a distributor 103, and a consumer 104.

The broadcaster 101 may be any source from which a television broadcast originates. For example, the broadcaster 101 may produce or provide a show for broadcast. An example of a broadcaster 101 may be Paramount Global of New York, NY that produces shows for its networks including, for example, Nickelodeon, MTV, Comedy Central, etc. Accordingly, when the transmission is a television broadcast, the broadcaster 101 may be a television network that represents an organization or entity that provides live or prerecorded content to television stations for distribution.

The television broadcast may be transmitted from the broadcaster 101 via the communication medium 102, which may be any transmission mode such as satellite communication, fiber communication, over the Internet, etc. The communication medium 102 may utilize any wired or wireless communication mechanism for the broadcaster 101 to transmit the television broadcast. Furthermore, the communication medium 102 may utilize a network architecture such that the television broadcast may be transmitted by the broadcaster 101 to a destination component of the broadcast system 100 in a direct or indirect route as well as to one or more destination components.

Through the communication medium 102, the broadcaster 101 may transmit the television broadcast to the distributor 103. The distributor 103 may be an intermediary that retransmits the television broadcast, particularly for a geographic region for which the distributor 103 is associated. The television broadcast may generally be re-transmitted with selected alterations at allowed time slots within the broadcast, e.g., slots for local advertising. If no alterations are made, a predetermined programming segment may be played out in the time slot as was included in the television broadcast that was received by the distributor 103.

The distributor 103 may include a variety of different entities or components. For example, the distributor 103 may be a multichannel video programming distributor (MVPD) which is a service provider delivering the television broadcasts received from the broadcaster 101. The MVPD may include satellite-based systems such as being a direct broadcast satellite provider, cable-based systems such as a cable television provider, a wireline based system such as a fiber optic provider, etc. In another example, the distributor 103 may be a multiple-system operator (MSO) which is a service provider delivering the television broadcasts received from the broadcaster 101 using multiple cable or direct broadcast satellite television systems. In a further example, the distributor 103 may be an affiliate station which is a local broadcaster of the television broadcasts received from the broadcaster 101, often independent of the broadcaster 101.

Using any communication mechanism, the distributor 103 may re-transmit the television broadcast to the consumer 104. The consumer 104 may be an end display device that shows video and/or plays audio associated with the television broadcast. The communication mechanism by which the distributor 103 retransmits the television broadcast to the consumer 104 may be based upon the available mechanisms utilized by the distributor 103, e.g., satellite, fiber, or cable. Generally, the consumer 104 has subscribed as a member with the distributor 103 and therefore has the appropriate components or devices by which the communication mechanism may be utilized for proper delivery of the television broadcasts.

It should be noted that the broadcast system 100 illustrated in FIG. 1 may include a plurality of further components or further entities. In some cases, there may be multiple instances of a communication medium 102 in between the same broadcaster 101 and distributor 103. In one example, the broadcaster 101 may utilize multiple different satellite transponders on multiple satellites (e.g., 1 or more transponders on each satellite) to transmit all the channels provided by the broadcaster. In another example, the broadcaster 101 may utilize a combination of satellite and terrestrial (e.g., fiber) communication mediums 102 to transmit all channels. Some distributors may receive channels via multiple communication mediums 102 to receive the full complement of channels provided by the broadcaster 101.

In another example, there may be further broadcasters that provide television broadcasts. Accordingly, there may be another broadcaster (not shown) in the broadcast system 100 that uses the communication medium(s) 102 to transmit the television broadcast to the distributor 103. In another example, there may be further distributors 103 that receive the television broadcasts from the broadcaster 101. Accordingly, there may be one or more distributors 103 that utilize the communication medium(s) 102 to receive the television broadcast from the broadcaster 101. In yet another example, there may be one or more consumers 104 or end devices that ultimately receive the transmission of the television broadcast from the distributor 103. In this manner, there may be a plurality of broadcasters 101 that each provides a television broadcast to a plurality of distributors 103 via any known communication medium(s) 102 that provides the television broadcast to a plurality of consumers 104.

A single broadcaster may transmit dozens or hundreds of different channels with each channel generally airing different material on different schedules. These schedules generally include multiple types of component parts including, e.g., long-form content (live or pre-recorded), advertisements/commercials, promos (e.g., for other shows on affiliated channels), and/or bumpers (small pieces of content relating to the long-form content). A playout system can access video content from multiple sources and switch the output feed according to a playlist dictating the schedule. In one example, a live feed for a channel, e.g., a live sporting event, can be received at a broadcast station and routed to the playout system. In another example, pre-recorded long-form content, e.g., a syndicated program, can be stored by the broadcasting entity, e.g., at a content database, and accessed by the playout system. The above examples can be considered primary content, e.g., a television program, for a channel.

FIG. 2 shows a diagram 110 for channel playout according to one example. In this example, the channel playout includes a national feed 117 for a channel. The diagram 110 includes a router 115 receiving redundant channel feeds from a primary playout system 111, e.g., a primary channel feed 112, and a secondary playout system 113, e.g., a secondary channel feed 114. The router 115 selects one of the feeds and provides a selected channel feed 116 as a national feed 117 for broadcast. It should be understood that the secondary playout system 113 may be omitted if no redundancy is required and, if additional redundancy is required, additional playout systems (e.g., a tertiary playout system) may be used. This may depend on the importance of the channel being broadcast.

The playout system(s) described above can provide various types of content in the channel feed. For example, live content and/or pre-recorded content can be accessed by the playout system as primary content for the channel. In some cases, pre-recorded content can be interspersed with the live content. In other examples, pre-recorded advertisements, commercials, promos, and/or bumpers can be stored by the broadcasting entity, e.g., at an advertisement database, and accessed by the playout system. In still another example, graphics can be accessed by the playout system. Promos, bumpers, and/or graphics can be created by the broadcaster, e.g., using graphic design software and/or video editing tools, then encoded into a digital format compatible with the playout system.

Accordingly, the playout system can access video content from multiple sources and switch the content to assemble the output channel feed according to the broadcast schedule. It is noted that additional types of content can be included in a broadcast schedule including, but not limited to, video effects (squeezes, fades, etc.), audio processing commands, external device commands, signaling metadata (e.g., SCTE-35, V-CHIP, CGMS-A, etc.), live feed and other video routing/switching, keyer commands, up-/down-convert commands, aspect ratio commands, and textual comments or requests for channel operations staff.

The playout system controls the transmission of the video content according to a playlist. The playlist for a channel is stored and managed at a broadcast facility and includes cues (e.g., avail tones) facilitating the insertion of content. The playout system can output a channel feed according to the playlist by switching from the different content sources.

In satellite broadcasting, a channel feed is output by a playout system and propagated through an uplink facility, e.g., a satellite uplink, for uplink transmission. Those skilled in the art understand that the satellite uplink comprises a chain of equipment, e.g., encoders, encryption, multiplexers, high-power amplifiers (HPAs), antenna dishes (satellite dishes), etc., for transmitting the uplink signal for reception at a satellite. The satellite includes a transponder for receiving the channels by the satellite uplink over uplink frequencies and retransmitting the channels over downlink frequencies. A satellite controller owns, operates, and leases the transponders on the various satellites used to receive the uplink signal and retransmit the channels.

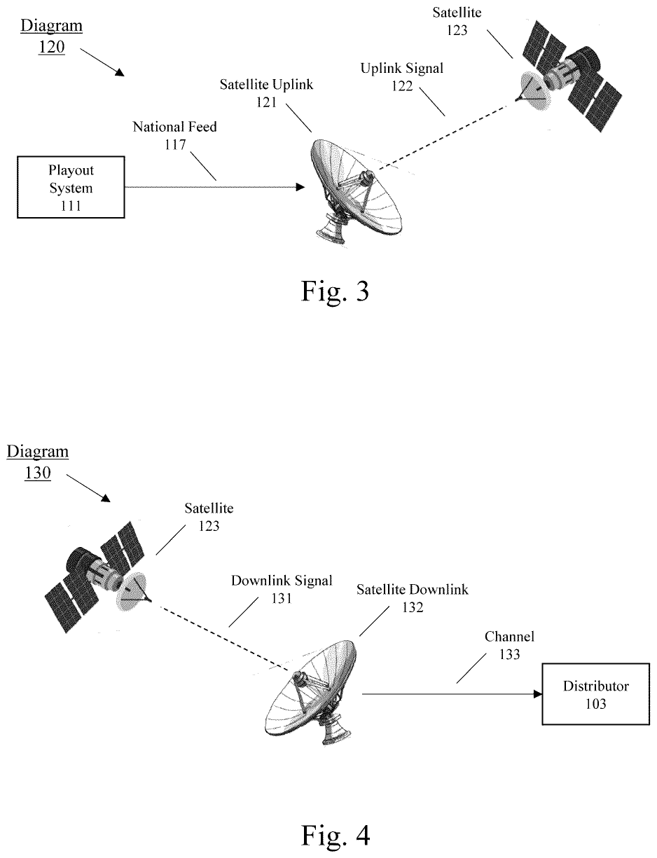

FIG. 3 shows an exemplary diagram 120 for transmitting an uplink signal 122 by a satellite uplink 121 according to one example. In this example, the primary playout system 111 of FIG. 2 outputs the national feed 117 to the satellite uplink 121 and the satellite uplink 121 transmits the uplink signal 122 for reception at a satellite 123. It is noted that the secondary playout system 113 and router 115 of FIG. 2 are omitted in FIG. 3 for clarity.

It is noted that a broadcaster can transmit multiple channels simultaneously over a single communications link. When broadcasting over satellite, it may be advantageous to combine multiple channels together to form a single package, especially in scenarios where bandwidth is limited. The channels may be combined by statistical multiplexing, or “statmuxing” (“multiplex” as a verb). In statistical multiplexing, the multiple distinct channels generally share a single communications link, with each channel encoded as a variable bitrate stream. Accordingly, an uplink signal may be composed of a single channel, e.g., the national feed 117 of a particular channel, or a grouping of channels combined into a multiplex. A single transmission site can transmit any number of channels (or groupings of channels) by any number of instances of the satellite uplink.

The satellite 123 of FIG. 3 can retransmit the channel(s) over downlink frequencies for reception at satellite downlink stations and distribution to customers, e.g., via local providers or distributors. The satellite downlink can be processed by a downlink facility operated by a distributor, e.g., a local affiliate. As discussed above, the distributor can retransmit the channel to any number of consumers, e.g., by satellite, fiber, or cable.

FIG. 4 shows a diagram 130 for receiving a downlink signal 131 by a satellite downlink 132 according to one example. The satellite downlink 132 is tuned to the downlink frequencies used by the transponder of the satellite 123. The downlink signal 131 is demodulated (and, in some cases, decrypted) and the channel 133 is provided to an entity further downstream in the broadcasting chain, e.g., the distributor 103 described above with regard to FIG. 1.

The distributor 103 may have its own playout system, wherein the channel received from the downlink facility is used as one of multiple sources of video content. The provider's playout system can access other content, e.g., local advertisements, and switch the output channel feed according to a broadcast schedule maintained by the distributor.

Accordingly, there can be multiple different entities in a broadcasting chain. There can be scenarios where one entity in the transmission chain of a channel may desire to output video content different from another entity in the transmission chain. In one illustrative example, a distributor may desire to overwrite or censor certain content in a received channel, e.g., a channel output by a broadcaster intended for a national audience (a primary channel or a national channel). In another illustrative example, a broadcaster may desire to provide certain content to some customers without providing the content to other customers. Accordingly, it may be preferable to modify the content of the channel for a particular group of viewers, e.g., viewers in a particular region, while broadcasting an unmodified version of the channel to viewers in other regions.

According to various exemplary embodiments described herein, alternate versions of channels can be generated and broadcast to a selected audience concurrently with an unmodified version of the channel (e.g., a national channel or national feed) being broadcast to a different (e.g., wider) audience. In one embodiment, an alternate playout system is configured to output an alternate channel while a primary playout system outputs a primary channel. In one embodiment, the alternate playout system accesses a special storage to add alternate content (special content) such as, e.g., special targeted promos, special graphics, or censoring features.

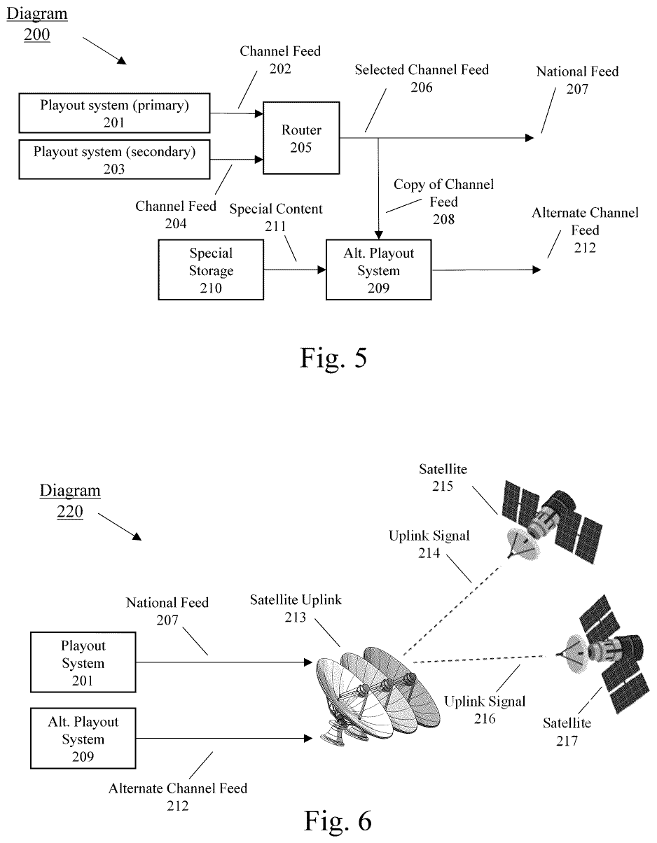

FIG. 5 shows a diagram 200 for alternate channel playout according to various exemplary embodiments. Similar to FIG. 2, the channel playout includes a national feed 207 for a channel and the diagram 200 includes a router 205 receiving redundant channel feeds, e.g., a primary channel feed 202 from a primary playout system 201 and a secondary channel feed 204 from a secondary playout system 203, selecting one of the feeds, and providing a selected channel feed 206 as the national feed 207 for broadcast.

In one aspect of these exemplary embodiments, a copy 208 of the selected channel feed 206 (which becomes the national feed 207) is provided to an alternate playout system 209. The alternate playout system 209 accesses a special storage 210 to receive special content 211, e.g., promos or graphics, for playout on an alternate channel feed 212. The alternate channel feed 212 may correspond to a modified national channel with selected special audio/video content inserted therein. It should be understood that, if redundancy is desired for the alternate channel, the copy 208 of the channel feed can be provided to multiple alternate playout systems and a router similar to the router 205 can select between the respective versions of the alternate feeds.

It should be understood that, in the present disclosure, one version of a broadcasted channel feed may be referred to as a primary channel and another version of the channel may be referred to as a secondary channel or alternate channel. The primary channel may correspond to a national channel. The term “national channel” as used herein refers to a channel provided by a broadcasting entity and intended for transmission to a first audience, e.g., broad transmission to a wide audience. The term “alternate channel” as used herein refers to a channel provided by the broadcasting entity and intended for transmission to a second audience, e.g., narrow transmission to a select audience. The alternate channel, which includes special content, may be intended for transmission in a local channel, e.g., a channel output by a downstream entity receiving the alternate channel.

It should be understood that the term “special” content is relative to the content of the national channel, e.g., the standard channel feed intended by the broadcaster to reach a larger audience. It should be further understood that the exemplary embodiments are not limited to any particular number of downstream entities (distributors, consumers, etc.) receiving a “primary” channel or any particular number of downstream entities (distributors, consumers, etc.) receiving an “alternate” or “secondary” channel. For example, the alternate version of the channel can, in some cases, reach a greater number of viewers than the primary version of the channel.

It is noted that some exemplary embodiments are described above with regard to satellite broadcasting. It should be understood that some aspects of the exemplary embodiments are also applicable to digital broadcasting or video on demand (VOD). In general, the playout system of a satellite channel utilizes serial digital interface (SDI) technology as a video transport. The SDI stream can be considered a raw, uncompressed format. When playout of a broadcast is performed using a cloud implementation or a virtual machine, the broadcast system may use an Internet Protocol (IP) stream.

It is an objective of the present embodiments to provide content in the alternate channel feed, e.g., long-form programming, advertisements, etc., that is identical to the primary channel feed with the exception of the alterations (special content) added to the alternate feed. It is a further objective of the present embodiments to ensure that the alternate channels are not mistakenly sent to an unintended audience. Accordingly, various aspects of these exemplary embodiments are described to achieve these objectives.

In one aspect of these exemplary embodiments, the primary playout system and the alternate playout system can assemble respective output channel feeds according to the same playlist, e.g., a national playlist for a channel. The primary playout system is configured to ignore certain commands in the national playlist, while the alternate playout system is configured to read these commands in the national playlist. In other words, the special commands included in the national playlist are inert on the national channel and can be actioned only by the alternate playout system. In the example shown in FIG. 5 above, the alternate playout system receives a copy of the national channel that has already been assembled by the primary playout system. Accordingly, the alternate playout system actions only the special commands to overlay the special content onto the previously assembled national feed. It is noted that the alternate playout system can be specially configured for the above described purposes relative to a typical playout system. A typical playout system can assemble a channel feed according to many disparate input sources, whereas the alternate playout system accesses only the national feed (output from the primary playout system) and the special storage for inserting the special graphics/promos. In alternative embodiments, the alternate playout system can assemble the alternate channel feed in full, e.g., by accessing the same content sources as the primary playout system (in addition to the special content storage).

In one embodiment, special asset ID prefixes, e.g., reserved keywords, are used in the playlist for the special content. The primary playout system can be configured to ignore commands in the playlist having these special asset ID prefixes, while the alternate playout system is configured to read commands in the playlist having these special asset ID prefixes.

In another aspect of these exemplary embodiments, the special content is placed on separate archive storage that is accessible only to the alternate playout system. The separate archive storage may be configured with a firewall, or another such access control mechanism, such that only selected playout systems can access the special content. Accordingly, the special content is protected such that it is not possible for the special content to be played on a regular national feed in error.

It may be desirable to broadcast alternate content to a selected audience, e.g., a single MVPD, MSO or region, to convey information to the selected audience not intended to be conveyed to a wider audience. It may be desirable to prevent any disruptions to the primary content of the channel (e.g., live or pre-recorded programming).

In some embodiments, the special content comprises a targeted video promo. A special video promo can be inserted into the schedule at any time. However, it may be desirable to insert the special video promo at the same time as a standard video promo is scheduled in the national playlist, such that the special video promo overrides, overlays or obscures (e.g., wallpapers over) the standard video promo in the national feed.

In some embodiments, the special promo is required to be a direct replacement for a promo included in the national channel. For example, a 15 second promo in the national feed must be replaced by a 15 second special promo. In some embodiments, no special promo can extend the time bounds of the standard promo (parent promo). If the special promo is too short, it will be padded with black; if it is too long, it will be cut off.

In some embodiments, the special content comprises graphics. A special graphic can be inserted into the schedule to overlay or obscure a portion of the national feed with the special graphic. In some embodiments, the special graphic can be stationary. However, a stationary graphic could be overwritten (e.g., obscured) by a receiving entity in the broadcast chain, e.g., the distributor.

Promo and graphic control is achieved by deleting the command from the national playlist, so there is no additional control surface or human operator required to operate the alternate version of the channel. Once the command (inert comment) is deleted from the national playlist, the graphic or promo is immediately removed from the alternate channel.

In some embodiments, the alternate playout system can generate an alternate channel in which objectionable content (e.g. alcohol, nudity, or other objectionable content in programming or advertisements) is wallpapered over to create an alternate version of a feed for a specific market or purpose. In some embodiments, the alternate playout system can replace entire shows or multi-hour blocks of shows.

Accordingly, the special content can comprise content that the broadcasting entity endeavors to show or not show to certain consumers. Additional aspects of these exemplary embodiments ensure that only some downstream entities can access the alternate stream carrying the special content.

In one embodiment, the broadcaster can force a distributor to receive only the alternate channel(s) by forcing the distributor to perform a satellite retune to an alternate transponder. This can be performed from a network operations center. It is automatic and cannot be changed or overridden by a distributor.

FIG. 6 shows an exemplary diagram 220 for transmitting a first uplink signal 214 carrying a primary channel and a second uplink signal 216 carrying an alternate channel according to various exemplary embodiments. In this example, the first uplink signal 214 includes the national feed 207 output by the primary playout system 201 (primary playout system) and the second uplink signal 216 includes the alternate channel feed 212 output by the alternate playout system 209. It should be understood that the national feed 207 may be included in a first grouping of channels combined into a first multiplex and the alternate channel feed 212 may be included in a second grouping of channels combined into a second multiplex. The national feed 207 and the alternate channel feed 212 are transmitted to the satellite uplink 213. In this example, the satellite uplink 213 includes multiple dishes for transmitting multiple uplink signals. The satellite uplink 213 transmits the first uplink signal 214 by a first dish to a first satellite 215 and the satellite uplink 213 transmits the second uplink signal 216 by a second dish to a second satellite 217.

Each satellite includes one or more transponders tuned to receive a specific uplink signal. Accordingly, although any number of uplink signals can reach a particular satellite, the satellite will receive and retransmit only those channels to which a transponder is tuned. In the example of FIG. 6, the first satellite 215 is tuned to the uplink frequencies carrying the first uplink signal 214 and the second satellite 217 is tuned to the uplink frequencies carrying the second uplink signal 216. Accordingly, the first satellite 215 does not receive and retransmit the alternate channel feed 212 included in the second uplink signal 216 and the second satellite 217 does not receive and retransmit the national feed 207 included in the first uplink signal 214. It should be understood that, in other embodiments, a single satellite can include multiple transponders, e.g., a first transponder tuned to the first uplink signal 214 and a second transponder tuned to the second uplink signal 216, such that the same satellite receives and retransmits both the national feed 207 and the alternate channel feed 212 by different transponders.

Accordingly, the primary transponder and the alternate transponder carry exact copies of a national channel with the exception of the special content carried by the alternate transponder. A first distributor authorized to decrypt the national channel can receive the national channel by tuning to downlink frequencies used by the transponder of the first satellite 215. A second distributor authorized to decrypt the alternate channel can receive the alternate channel by tuning to downlink frequencies used by the transponder of the second satellite 217.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a Linux based OS, a mobile device having an operating system such as iOS, Android, etc. In a further example, the exemplary embodiments of the above-described method may be embodied as a computer program product containing lines of code stored on a computer readable storage medium that may be executed on a processor or microprocessor. The storage medium may be, for example, a local or remote data repository compatible or formatted for use with the above noted operating systems using any storage operation.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A system for alternate channel generation, comprising:
a first channel playout system configured to read a playlist and output a first channel feed according to the playlist, the first channel playout system configured to ignore one or more special commands in the playlist;
a second channel playout system configured to read the playlist and output a second channel feed according to the playlist, the second channel playout system configured to read the one or more special commands in the playlist; and
a storage accessible by the second channel playout system and not accessible by the first channel playout system, the storage configured to store special content including at least one of special video content or special graphics,
wherein the second channel playout system is configured to read the one or more special commands in the playlist causes the second channel playout system to retrieve the special content and insert the special content in the second channel feed, and
wherein the first channel playout system does not insert the special content in the first channel feed.

2. The system of claim 1, wherein a first special command including a special prefix, the first channel playout system reading the special prefix causing the first special command to be inert, the second channel playout system reading the special prefix causing the first special command to be actioned.

3. The system of claim 2, wherein the special prefix comprising an asset ID prefix comprising a reserved keyword.

4. The system of claim 1, wherein the playlist includes a first standard command for inserting a first standard video content and a first special command for inserting a first special video content,
the first channel playout system ignoring the first special command and outputting the first standard video content,
the second channel playout system reading the first special command and outputting the first special video content, wherein, when the first special video content overlaps the first standard video content, the first special video content overrides the first standard video content in the second channel feed.

5. The system of claim 4, wherein the first standard video content and the first special video content comprise a same duration so that the first special video content directly overlaps the first standard video content.

6. The system of claim 4, wherein the first standard video content comprises a first duration and the first special video content comprises a second duration, and
wherein, when the first duration is greater than the second duration, the second channel playout system outputs the first special video content for the second duration then outputs black for a remainder of the first duration.

7. The system of claim 4, wherein the first standard video content comprises a first duration and the first special video content comprises a second duration, and
wherein, when the second duration is greater than the first duration, the second channel playout system cuts off the first special video content and switches to a different playout source.

8. The system of claim 1, wherein the playlist includes a first special command for inserting a first special graphic in the second channel feed for a predetermined duration.

9. The system of claim 8, wherein the first special graphic comprises a crawl graphic.

10. The system of claim 1, further comprising:
a first satellite uplink transmitting the first channel feed on first uplink frequencies to a first satellite for retransmission to a first downlink station; and
a second satellite uplink transmitting the second channel feed on second uplink frequencies to a second satellite for retransmission to a second downlink station.

11. The system of claim 1, wherein the second channel playout system receives the first channel feed from the first channel playout system and actions only the one or more special commands to overlay the first channel feed with the special content.

12. A method for alternate channel generation, comprising:
loading a playlist to a first channel playout system configured to read the playlist and output a first channel feed according to the playlist, the first channel playout system configured to ignore one or more special commands in the playlist;
loading the playlist to a second channel playout system configured to read the playlist and output a second channel feed according to the playlist, the second channel playout system configured to read the one or more special commands in the playlist;
accessing a storage by the second channel playout system, the storage configured to store special content including at least one of special video content or special graphics;
based on the one or more special commands, retrieving from the storage the special content;
inserting the special content in the second channel feed;
outputting, by the second channel playout system, the second channel feed including the special content; and
outputting, by the first channel playout system, the first channel feed not including the special content.

13. The method of claim 12, wherein the second channel playout system receives the first channel feed from the first channel playout system and actions only the one or more special commands to overlay the first channel feed with the special content.

14. The method of claim 12, wherein a first special command includes a special prefix, the first channel playout system reading the special prefix causing the first special command to be inert, the second channel playout system reading the special prefix causing the first special command to be actioned, the special prefix comprising an asset ID prefix comprising a reserved keyword.

15. The method of claim 12, wherein the playlist includes a first standard command for inserting a first standard video content and a first special command for inserting a first special video content,
the first channel playout system ignoring the first special command and outputting the first standard video content,
the second channel playout system reading the first special command and outputting the first special video content, wherein, when the first special video content overlaps the first standard video content, the first special video content overrides the first standard video content in the second channel feed.

16. The method of claim 15, wherein the first standard video content comprises a first duration and the first special video content comprises a second duration,
wherein, when the first duration is greater than the second duration, the second channel playout system outputs the first special video content for the second duration then outputs black for a remainder of the first duration,
wherein, when the second duration is greater than the first duration, the second channel playout system cuts off the first special video content and switches to the first channel feed.

17. The method of claim 12, wherein the playlist includes a first special command for inserting a first special graphic in the second channel feed for a predetermined duration, wherein the first special graphic changes location over time on the second channel feed.

18. The method of claim 12, further comprising:
transmitting the first channel feed by a first satellite uplink on first uplink frequencies to a first satellite for retransmission to a first downlink station; and
transmitting the second channel feed by a second satellite uplink feed on second uplink frequencies to a second satellite for retransmission to a second downlink station.

19. The method of claim 18, further comprising:
transmitting a command to the second downlink station causing the second downlink station to tune to downlink frequencies transmitted by the second satellite.
